(19) United States
(12) Patent Application Publication
(10) Pub. No.: US 2014/0272793 A1
(43) Pub. Date: Sep. 18, 2014

(54) DENTAL IMPLANT INSTRUMENTATION AND METHODS

(71) Applicant: Grant Dental Technology Corporation, Colorado Springs, CO (US)

(72) Inventors: James Grant, Colorado Springs, CO (US); Bradley William Renehan, Colorado Springs, CO (US); Duncan Stewart, Colorado Springs, CO (US)

(73) Assignee: Grant Dental Technology Corporation, Colorado Springs, CO (US)

(21) Appl. No.: 13/841,761

(22) Filed: Mar. 15, 2013

(51) Int. Cl. A61C 8/00

(52) U.S. Cl. CPC A61C 8/0089
USPC 433/174

(57) ABSTRACT

Embodiments of the invention described herein include various instrumentation components designed to install a dental implant. They are provided in order to secure a base platform and to accurately prepare a central opening which receives an implant screw that secures the base platform to the patient's jawbone.

### CROSS REFERENCE TO RELATED APPLICATIONS

This application is related to U.S. patent application Ser. No. 13/014,526, filed Jan. 26, 2011, U.S. patent application Ser. No. 12/694,911, filed Jan. 27, 2010, U.S. patent application Ser. No. 12/243,676, filed Oct. 1, 2008, and U.S. patent application Ser. No. 12/074,524, filed Mar. 4, 2008, the complete disclosures of which are herein incorporated by reference.

### FIELD OF THE INVENTION

Embodiments of the present invention relate generally to dental implants, instrumentation for implant surface preparation, as well as methods of use of the implants and instrumentation.

### BACKGROUND

Implants are becoming a more common way to replace one or more lost teeth. Because they are relatively low maintenance and durable, people tend to prefer implants to bridges. Although technicians have been improving implants and their implantation, further improvements are still needed. For example, one of the problems with implants is that they must be precisely positioned, or else food and other debris can collect in gaps beneath the crown portion of the implant. One system of dental platform assemblies, implants, and methods for their use is described in U.S. Publication No. 2011/0151408, assigned to Grant Dental Technology Corporation. This publication outlines the creation of an appropriately sized recess in a patient's jawbone for receiving an implant. A pilot hole is then created in the recess that can accommodate the size of the base attachment screw of the implant, and a base plate is positioned in the recess and secured in place by the screw. A collar or crown supporting mechanism may then be positioned over and affixed to the base plate in order to support a crown attachment fastener and a crown.

However, in order to position these implants effectively, the portion of the patient's jawbone that is shaped to receive the base plate must be prepared precisely, and the pilot hole that accommodates the base attachment screw should be formed at an appropriate angle, such as perpendicular to the base plate/platform. If the position of the pilot hole is offset of skewed, even just slightly, the platform can be dislodged when any amount of torque is applied to the screw. Accordingly, embodiments described herein provide instrumentation and implantation methods to ensure effective implantation of dental implants having a base platform that is secured with a fastener implant screw. Embodiments provide a screw-retained platform guide, a modular handle to secure this and other guides, a platform guide/template, an implant drill guide, and a platform holder.

### BRIEF SUMMARY OF THE INVENTION

Embodiments of the invention described herein provide various instrumentation components designed to prepare a dental surgical site to receive a dental implant. The instruments described are configured to form and prepare a recess cavity in a patient's jawbone, and to drill a precise hole/central opening through the recess, and to assist in the installation of the implanted devices.

One particular embodiment provides a platform guide that comprises a guide member having a top, a bottom, and an outer periphery. The guide member is sized and shaped to be placed over an implant site of a patient's jawbone. Also, the guide member defines a space that extends between the top and the bottom, and this space defines an interior edge that guides a rotatable cutting tool to create a recess in the patient's jawbone. The space is sized and shaped to match the size and shape of a base platform that is to be subsequently inserted into the jawbone after creation of the recess. Optionally, at least one arm may extend upwardly from the guide member. The arm is configured to be grasped by a grasping tool to facilitate placement of the platform guide at the implant site.

In one aspect, the guide member further defines a hole that is configured to receive a screw that temporarily secures the guide member to the patient's jawbone. In another aspect, at least one extension is included that extends from the guide member to assist in holding back tissue.

In another embodiment, the invention provides a drill guide that comprises a drill guide body having a top, a bottom, and an outer periphery. The drill guide body is sized and shaped to be placed into a previously-formed recess in a patient's jawbone. The drill guide body defines a through hole that extends between the top and the bottom. This through hole is configured to receive a drill bit to create a hole in a central portion of the recess in the patient's jawbone, with the drill guide assisting in stabilizing the drill bit at a desired angle while drilling. Further, the drill guide body is sized and shaped to match the size and shape of the recess to further facilitate proper drilling of the hole. Optionally, at least one arm may extend upwardly from the drill guide body and may be configured to be grasped by a grasping tool to facilitate placement of the drill guide into the recess.

In yet another embodiment, the invention provides a platform holder that comprises a platform body defining a central opening that is sized and shaped to permit an implant screw to be inserted through the opening. At least one peg (or other attachment features) extends from the platform body. The peg is configured to be inserted into an opening in a base platform that is to be placed into a recess in a patient's jawbone. At least one grasping element extends from the platform body to facilitate grasping of the platform holder with a grasping tool.

In some cases, one or more components may be included in a dental system. For example the dental system could be provided in a kit and include one or more of the following: An implant guide, a drill guide, a platform holder, a platform, an implant screw, a securing screw, and the like.

In a further embodiment, the invention provides an exemplary method that includes the step of grasping a guide member having a top, a bottom, and an outer periphery. The guide member defines a space that extends between the top and the bottom. The guide member is placed over an implant site of a patient's jawbone. Also, a rotatable cutting tool is placed into the space, and while the cutting tool is rotating, used to remove portions of the patient's jawbone defined by the space. The space further defines an interior edge that guides the rotatable cutting tool to create a recess in the patient's jawbone corresponding to the space. The space is sized and shaped to match the size and shape of a base platform that is to be subsequently inserted into the jawbone after creation of the recess.

In one optional step, the platform guide is secured to the patient's jawbone using a screw that is inserted through an opening in the guide member. In some cases, the guide member includes an extension that may be moved adjacent any tissue to generally prevent the tissue from interfering with operation of the cutting tool.

In a further step, a hole is drilled into the previously-formed recess using a drill bit. This hole is sized to receive an implant screw. To facilitate drilling of the hole, a drill guide may be placed into the recess. The drill guide defines a through hole, and the drill bit is placed through the through hole while the drill guide is within the recess.

In yet another step, a platform is placed into the recess. The platform is generally sized and shaped to match the size and shape of the recess, and the platform includes an opening that is configured to receive an implant screw. In some cases, the platform is placed into the recess using a platform holder having an interface that engages with the platform and assists in holding the platform within the recess. With the platform in place, an implant screw may be placed through the opening in the platform and into the previously-drilled hole. In some cases, the implant screw may also be placed through an aperture in the platform holder while the platform holder holds the platform in place within the recess.

### BRIEF DESCRIPTION OF THE DRAWINGS

FIG. 1 shows an exploded side view of one embodiment of an implant that may be implanted using the instrumentation described herein.

FIG. 2 shows one embodiment of a base platform that forms part of the implant of FIG. 1.

FIG. 3 shows a side plan view of a recess created between a patient's teeth, for receipt of an implant of FIG. 1.

FIG. 4a shows a top plan view of one embodiment of a screw-retained platform guide for creation of the recess shown in FIG. 3.

FIG. 4b shows a bottom plan view of the screw-retained platform guide of FIG. 4a.

FIG. 5 shows a perspective view of screw-retained platform guide in use, along with a modular handle for maneuvering of the guide.

FIG. 6a shows a side and exploded view of one embodiment of a module handle.

FIG. 7a shows a top plan view of one embodiment of a platform guide.

FIG. 7b shows a side plan view of the platform guide of FIG. 7a.

FIG. 8 shows a recess with a central opening having an implant positioned therein.

FIG. 9a shows a top view of one embodiment of an implant drill guide.

FIG. 9b shows a side plan view of the implant drill guide of FIG. 9a with an implant drill positioned therein.

FIG. 9c shows a side view of an alternate embodiment of an implant drill guide.

FIG. 10 shows one embodiment of an implant drill.

FIG. 11 shows a perspective view of the portion of the surgery where a base platform is positioned in the recess.

FIG. 12 shows one embodiment of a platform holder/optional drill guide.

FIG. 13 shows an alternate embodiment of a platform holder/optional drill guide.

### DETAILED DESCRIPTION

The instruments described herein are useful for preparing a patient's jawbone to receive an implant of the type described, for example, by U.S. Publication No 2011/0151408, the entire contents of which are incorporated herein by reference. Examples of such implants are shown in FIGS. 1-2 and generally include a base platform 10 with a central opening 12, and an implant fastener 14 (such as a screw) that is positioned within the central opening 12 in order to secure the platform 10 to the patient's jawbone. An abutment 16 may be positioned over the base platform 10, and a crown or other tooth restoration element is positioned over the abutment 16.

In order to position the implant, a section of bone (from a section of the jaw where a tooth is missing) is removed to form a recess 20, as shown in FIG. 3. The recess is formed to have a similar shape and size as the base platform 10 so that only minimal bone growth will be needed in order to fully secure the platform to the bone. In order to form the recess 20, a router, drill, or other appropriate instrument may be used to remove and shape the bone. One example of a template that may be used to guide such instruments in order to form a precisely shaped recess is the screw-retained platform guide 22, as shown in FIGS. 4a and 4b. This guide 22 has an inner space 24 with an inwardly protruding securement portion 26. In use, the guide 22 is positioned over the space to be prepared, bounding the space that is to be prepared to receive the implant. An example is shown in FIG. 5. Guide 22 may be provided in a number of sizes or with differently shaped inner spaces 24, in order to accommodate preparation of the space for differently shaped tooth areas. Hence, inner space 24 may be specifically sized and shaped to match the subsequently implanted platform. As such, guides with differently sized and shaped inner spaces may be used.

A first outward arm 28 extends toward the patient's lingual surface and a second outward arm 30 extends toward the patient's buccal surface when the guide 22 is positioned. Optionally, one or more extensions 31 may be provided to help hold back tissue. However, in some cases, extensions 31 may not be needed and may not be included. Arms 28, 30 are shown being outwardly angled, but it is possible for arms to be inwardly angled or to extend straight upward. There are also two arms (28, 30) shown, one on each side of space 24, but it should be understood that there only need be a single arm provided, in order to provide an element for grasping and maneuvering of guide 22. Also, in some cases, another type of tool could be used so that no arm would be needed. Arms 28, 30 provide a standard handle function, and may also function to hold tissue back to provide a clear working space for site preparation. Each arm 28, 30 has a nodule 32 at the end thereof. The nodule is distinctly shaped such that instrumentation may be used to hold and move the guide 22.

For example, a modular handle 34, as shown in FIG. 6, may be used to maneuver to guide 22 into place and to secure it temporarily. (Once positioned, a screw or other fastener element is positioned in the securement portion 26 in order to more completely hold the guide 22 in place.) The modular handle 34 has a first end 36 with a downwardly-turned mouth 38 with an opening 40 that is similarly shaped to the nodules 32. An internal spring-loaded rod 42 is actuated with a push button 44, which allows the modular handle 34 to grasp and release the nodules 32 of the guide 22 (and other components described herein.) It will be appreciated that other latching mechanisms may also be used in order to grasp and release the nodules.

Once the guide 22 has been properly positioned, a set screw or other fastener element is positioned in the securement portion 26 in order to more completely hold the guide 22 in place. A router or drill is then used to follow the inner route created by the inner space 24 in order to create the recess 20 in the patient's bone. The screw is removed from the securement portion 26, and the modular handle 34 is then used to remove the guide 22. The guide 22 may be turned the opposite way (and re-secured via another fastener positioned in the securement portion 26) in order to create the other side of the recess (the side blocked by the edge and securement portion 26 of the guide 22). Alternatively, the dental surgeon may be able to complete preparation of the other side of the recess without the guide 22. There will be a raised area in the bone where the screw in the securement portion 26 was positioned, and that raised bone is also removed to provide a rectangular recess, as shown in FIG. 3. It will be appreciated that other guides may be used to create different sizes and shapes of recesses depending on the need and/or shape and size of the resulting implanted device. For example, the shape may be eccentric, oval, triangular, circular, oblong, and the like.

Instead of using the screw-retained platform guide 22 or in addition to its use, there is also provided a platform guide or template 50, as shown in FIGS. 7a and 7b. The platform guide 50 may be used in conjunction with the guide 22, such that once the guide 22 has been used to create one side of the recess 20 and removed, the second platform guide or template 50 may be used to create the other side. The template 50 is not screw-retained, so it provides an inner space 52 that generally defines an opening to match the dimensions and shape of the implanted platform and can be used to guide instruments in removing material that was not removed with the screw-retained platform guide 22. The template guide 50 also features outwardly angled arms 56 with shaped nodules 58 at the ends, which correspond to similarly shaped portions on the modular handle 34 for placing and removing template guide 50 in the desired position. Arms 56/nodules 58 provide a standard handle function, and also function to hold tissue back to provide a clear working space for site preparation.

If desired, the platform guide/template 50 may be used on its own, instead of the screw-retained platform guide 22, to create the recess 20. The template 50 may be positioned in the desired location (similar to the location shown in FIG. 5), and the inner space 52 is used to guide the instruments in use.

Once the recess cavity has been created and cleaned, the next step is to create a central opening 46 in the recess cavity 20 for receipt of the implant screw 14, as shown in FIG. 8. A pilot hole may be formed in the recess, and progressively larger drill bits with increasing diameters may need to be used until the initial pilot hole is large enough to receive the implant screw 14. However, simply estimating the angle for the formation of the hole that is drilled through the recess (and which receives the implant screw or fastener) and eye-balling its formation to be basically perpendicular (or other desired angle) to the base platform is not optimal. Additionally, drilling directly through the central opening 12 of the base platform 10 to form the central opening is not optimal. If the angle of the pilot hole created for the implant screw is even slightly off, the torque used to position the screw can cause the platform to dislodge, creating pain for the patient and potentially damaging the bone growth, or could damage the implant platform. It is also preferable to ensure that the hole that is ultimately formed in the jawbone is at the precise center of the central opening 12 of the platform 10. Accordingly, an implant drill guide 60 and/or a platform holder/optional drill guide 82 are provided.

An example of an implant drill guide 60 is shown in FIG. 9a. In addition to being used as a guide for the drill, guide 60 may also be used as a size guide to check that the dimensions of the recess are correct. In use, the drill guide 60 may be positioned in the recess 20 that has been created in order to gauge the size and depth of the recess 20, and to confirm that enough bone has been removed. As shown in FIG. 9b, the lower level 62 of the guide 60 has angled base sides 61 that match the angled portions 11 of the base platform 10. If the guide 60 does not sit firmly and completely in the recess 20, further shaping of the recess may be needed. (If the recess needs to be reshaped, the surgeon may revert back to using one or both of the above-described templates to reshape the recess 20.) The drill guide 60 may be provided in a number of sizes or base dimensions in order to match variously-sized base platforms and/or to accommodate variously-sized implant drills and/or for preparation of differently shaped recesses. Drill guide 60 may be fabricated in various sizes that match the desired drill dimensions.

Assuming that the recess has been properly sized, the implant drill guide 60 may then be used to guide an implant drill in forming a central opening in the recess. In the particular configuration shown in the drawings, the guide 60 generally has a stepped configuration, with its lower level 62 having an external shape that corresponds generally to the intended shape of the base platform 10. However, the base of guide 60 in many cases may be configured to match the size and shape of the base of the platform, and need not be stepped. Further, guide 60 could be fashioned in a variety of outer shapes and configurations, such as a rod/post, a small tab, or the like, that permits hemostats to grasp and manipulate. Drill guide 60 in some embodiments may be fashioned to fit securely into the recess and to mimic the central opening 12 of the platform 10. The lower level 62 also has a drill guide opening 64, which corresponds to the central opening 12 of the platform 10 and which is shaped and designed to receive a drill bit for preparing the pilot hole for the implant screw. The drill guide opening 64 is configured such that it is centered in the inner space 52 in use, and perpendicular (or at another desired angle) to the intended position of the platform 10. Various guides 60 may be provided with variously-sized guide openings 64, if desired.

A mid-level 66 of the guide 60 features a drill portion support 68. Drill portion support 68 is shown as a curved face which allows a drill portion to rest against the face and be supported and held directly vertical or perpendicular during site preparation. The uppermost portion of the guide 60 is formed as outwardly angled arms 70 with nodules 72, similar in use, form, and function to the previously-described arms.

An alternate embodiment of a drill guide 60′ is shown in FIG. 9c. This drill guide 60′ has a raised enclosed central tube portion 63 with an opening 64′ therein, which serves to guide the drill bit 76. Although opening 64′ is shown in a tube portion, it will be appreciated that any structure capable of defining such an opening could be used. Providing an extended piece of structural material (such as enclosed tube portion 63) helps to control the angle and minimize wobbling during drilling. In this way, the drill bit may be maintained at a perpendicular (or other desired) angle during drilling, in order to ensure that the central opening 46 created is precisely perpendicular (or other desired angle) to the platform 10. Hence, drill guide 60′ helps to maintain the drill bit at the desired angle, and also centered, so that the resulting cut-out feature and drilled hole will match the orientation of the implanted platform and screw anchor.

Once the pilot hole has been properly formed, multiple implant drill bit portions 76, increasing in size, are used to form the final central opening for receiving the implant screw. As example of a drill bit portion 76 being inserted through a drill guide 60 is shown in FIG. 9a, and an example of an implant drill bit portion 76 is shown in FIG. 10. Implant drill portion 76 has a drill end 78 and a stop 80, which abuts the drill guide opening 64 of the implant drill guide 60 to ensure that the drill end 78 does not extend too deeply into the bone. Alternative sizes (lengths and widths) of implant drill portion 76 may be provided.

Once the recess 20 and the central opening have been formed in the bone, the base platform 10 is then positioned in the recess 20, as shown in FIG. 11. The central opening 12 of the recess is directly over the central opening 46 that has been created in the bone. Base platform 10 may have screw openings 13 which are provided to receive small screws or fasteners that secure the platform 10 in place.

One component that may be used to ease the placement of the base platform 10 into the recess 20 is a platform holder 82. (As discussed further below, the platform holder may also serve as a drill guide if desired.) One example of a platform holder 82 is shown in FIG. 12. The base platform 10 and the platform holder 82 may be packaged together (i.e., sealed in a sterile package together) so that the platform holder 82 can be used to easily guide the platform 10 into the desired position. The platform holder 52 may also serve to stabilize the platform 10 during implantation of the implant screw. Holder 82 has a platform securement feature, which may be one or more lower pegs 84 extending from the base of holder 82. These pegs are designed to be positioned in one or more detents 85 in the upper surface of the platform 10. These elements can help secure the platform holder 82 to the platform 10 so that the two components can be moved and positioned as one-piece. (Alternatively, it should be understood that pegs may be positioned on the upper surface of the platform and detents may be provided in the base of holder, as long as there is a secure connection between these elements.)

Additionally, when the implant screw 14 is positioned through the central opening 12 of the platform 10, the platform may twist or torque due to the pressure and torque required to position the implant screw. In order to confirm that the base platform 10 will not twist or turn the platform holder 82 may be positioned over the base platform 10 and to hold it in place. i.e., to prevent it from twisting or torquing. The platform holder 52 generally has a base platform connecting portion or securement feature and a handle portion. The platform securement feature may be one or more lower pegs 84 extending from the base of holder 82, although it should be understood that any feature that will allow the platform holder 82 attach to the platform 10 is possible for use. If used, the pegs are designed to be positioned in one or more detents 85 in the upper surface of the platform 10. Alternatively, it should be understood that there may be pegs positioned on the upper surface of the platform and detents may be provided in the base of holder, as long as there is a secure connection between these elements to prevent twisting or rotation of the platform upon pressure or torque.

The holder 82 features a central opening 86, through which the implant screw 14 may be passed. It also features one or more handle portions or holder connection features 88 at either an upper or side surface, which allows easier connection to a modular handle 34 or other maneuvering instrument. An alternate embodiment of a holder 82 is shown in FIG. 13, which illustrates a C-shaped holder 83 that allows the surgeon to view the insertion of the implant screw during the procedure. In one embodiment, the holder is intended to be disposable and may thus be manufactured of plastic or a similar material.

It is also possible to use the platform holder 82 as a drill guide, instead of using implant drill guide 60. In this method, once the recess has been formed, the platform holder 82 (optionally packaged with the base platform 10) is positioned over the recess and positions the platform in the recess. Then, the platform holder 52 is maintained in place, and the central opening 86 in the holder 82 provides a space to receive a drill portion for creating the central opening 46 in the recess 20. In this capacity, the platform 82 serves the function of an optional drill guide. This can prevent the need to provide the additional drill guide (described above) as a part of the system, saving an extra step and instrumentation expense. The holder 82 may then remain in place as described, in order to secure the platform 10 during insertion and securement of the implant screw 14.

Once the platform and screw have been properly positioned, the surgeon may position a healing cap over the system and allow the site to heal for three to six months. Once the site has healed, the surgical site may be re-accessed, the healing cap removed, and an abutment positioned over the platform base, which is designed to receive a crown or other tooth restoration element.

Changes and modifications, additions and deletions may be made to the structures and methods recited above and shown in the drawings without departing from the scope or spirit of the invention and the following claims.

What is claimed is:

1. A platform guide, comprising:
a guide member having a top, a bottom, and an outer periphery, wherein the guide member is sized and shaped to be placed over an implant site of a patient's jawbone, wherein the guide member defines a space that extends between the top and the bottom, wherein the space defines an interior edge that guides a rotatable cutting tool to create a recess in the patient's jawbone, wherein the space is sized and shaped to match the size and shape of a base platform that is to be subsequently inserted into the jawbone after creation of the recess;
at least one arm extending upwardly from the guide member, wherein the arm is configured to be grasped by a grasping tool to facilitate placement of the guide at the implant site.

2. A platform guide as in claim 1, wherein the guide member further defines a hole that is configured to receive a screw that temporarily secures the guide member to the patient's jawbone.

3. A platform guide as in claim 1, further comprising at least one extension that extends from the guide member to assist in holding back tissue.

4. A drill guide, comprising:
a drill guide body having a top, a bottom, and an outer periphery, wherein the drill guide body is sized and shaped to be placed into a previously-formed recess in a patient's jawbone, wherein the drill guide body defines a through hole that extends between the top and the bottom, wherein the through hole is configured to receive a drill bit to create a hole in a central portion of the recess in the patient's jawbone, and wherein the drill guide body is sized and shaped to match the size and shape of the recess; and
at least one arm extending upwardly from the drill guide body, wherein the arm is configured to be grasped by a grasping tool to facilitate placement of the drill guide into the recess.

5. A dental system, comprising:
an implant guide comprising:
a guide member having a top, a bottom, and an outer periphery, wherein the guide member is sized and shaped to be placed over an implant site of a patient's jawbone, wherein the guide member defines a space that extends between the top and the bottom, wherein the space defines an interior edge that guides a rotatable cutting tool to create a recess in the patient's jawbone, wherein the space is sized and shaped to match the size and shape of a base platform that is to be subsequently inserted into the jawbone after creation of the recess;
at least one arm extending upwardly from the guide member, wherein the arm is configured to be grasped by a grasping tool to facilitate placement of the guide at the implant site; and
a drill guide comprising:
a drill guide body having a top, a bottom, and an outer periphery, wherein the drill guide body is sized and shaped to be placed into the previously-formed recess in the patient's jawbone, wherein the drill guide body defines a through hole that extends between the top and the bottom, wherein the through hole is configured to receive a drill bit to create a hole in a central portion of the recess in the patient's jawbone, and wherein the drill guide body is sized and shaped to match the size and shape of the recess; and
at least one arm extending upwardly from the drill guide body, wherein the arm is configured to be grasped by a grasping tool to facilitate placement of the drill guide into the recess.

6. A platform holder, comprising:
a platform body defining a central opening that is sized and shaped to permit an implant screw to be inserted through the opening;
at least one peg extending from the platform body, wherein the peg is configured to be inserted into an opening in a base platform that is to be placed into a recess in a patient's jawbone; and
at least one grasping element extending from the platform body to facilitate grasping of the platform holder with a grasping tool.

7. A dental method, comprising:
grasping a guide member having a top, a bottom, and an outer periphery, wherein the guide member defines a space that extends between the top and the bottom;
placing the guide member over an implant site of a patient's jawbone;
placing a rotatable cutting tool into the space, and while the cutting tool is rotating, removing portions of the patient's jawbone defined by the space, wherein the space further defines an interior edge that guides the rotatable cutting tool to create a recess in the patient's jawbone corresponding to the space, and wherein the space is sized and shaped to match the size and shape of a base platform that is to be subsequently inserted into the jawbone after creation of the recess.

8. A method as in claim 7, further comprising securing the platform guide to the patient's jawbone using a screw that is inserted through an opening in the guide member.

9. A method as in claim 7, wherein the guide member includes an extension, and further comprising moving the extension adjacent any tissue to generally prevent the tissue from interfering with operation of the cutting tool.

10. A method as in claim 7, further comprising drilling a hole into the previously-formed recess using a drill bit, wherein the hole is sized to receive an implant screw.

11. A method as in claim 10, further comprising placing a drill guide into the recess, wherein the drill guide defines a through hole, and placing the drill bit through the through hole while the drill guide is within the recess.

12. A method as in claim 10, further comprising placing a platform into the recess, wherein the platform is generally sized and shaped to match the size and shape of the recess, and wherein the platform includes an opening that is configured to receive an implant screw.

13. A method as in claim 12, wherein the platform is placed into the recess using a platform holder having an interface that engages with the platform and assists in holding the platform within the recess.

14. A method as in claim 13, further comprising placing an implant screw through the opening in the platform and into the previously-drilled hole.

15. A method as in claim 14, wherein the implant screw is also placed through an aperture in the platform holder while the platform holder holds the platform in place within the recess.
